(19) United States
(12) Patent Application Publication
(10) Pub. No.: US 2024/0309847 A1
(43) Pub. Date: Sep. 19, 2024

(54) WIND TURBINE TOWER INSTALLATION APPARATUS, WIND TURBINE SUPPORT TOWER AND METHOD

(71) Applicant: Nekkar ASA, Kristiansand S (NO)

(72) Inventors: Yngvar Borø, Søgne (NO); Ricardo Nuno Correia, Flekkerøy (NO); Adrian Mihai Orasanu, Flekkerøy (NO); Arild Andersen, Kristiansand (NO)

(73) Assignee: Nekkar ASA, Kristiansand S (NO)

(21) Appl. No.: 18/576,930

(22) PCT Filed: Jun. 22, 2022
(86) PCT No.: PCT/NO2022/050142

§ 371 Date: Jan. 5, 2024

(30) Foreign Application Priority Data
Jul. 7, 2021 (NO) 20210880

(51) Int. Cl. F03D 13/10; E04H 12/34; F03D 13/20

(52) U.S. Cl. CPC F03D 13/10; E04H 12/342; F03D 13/20; F05B 2230/61

(57) ABSTRACT

A wind turbine tower, wind turbine tower installation apparatus and methods of erecting a wind turbine tower. The wind turbine tower installation apparatus has a frame having a guide for positioning the apparatus on an installed portion of a tower, a platform for supporting wind turbine components on the frame, and a mechanism for transversely positioning the supported wind turbine component in alignment with the tower. A lifting mechanism is provided for moving the apparatus longitudinally up and down the tower. The apparatus further has an adaptor frame defining a collar for receiving and aligning the free end of the installed portion of the tower and the adjacent end of the subsequent tower section. The wind turbine support tower has a mating interface having complimentary sleeve portions one of which has a radially displaceable locking ring for engaging a radially extending feature of the other sleeve portion.

### CROSS-REFERENCE TO RELATED APPLICATIONS

This application is the U.S. national stage application of International Application No. PCT/NO2022/050142, filed Jun. 22, 2022, which international application was published on Jan. 12, 2023 as WO 2023/282756 in the English language. The International Application claims priority to Norwegian patent application Ser. No. 20/210,880, filed Jul. 7, 2021. The international application and Norwegian application are both incorporated herein by reference, in their entirety.

### FIELD

The present invention relates to a wind turbine tower, wind turbine tower installation apparatus and methods of erecting a wind turbine tower.

### BACKGROUND

The invention relates to the technical field of wind turbines, and more specifically to the installation and construction of wind turbines.

For increased efficiency it is desirable to provide wind turbines with larger rotor areas (to increase the capacity of the turbine) and to position the turbine at a higher elevation (as wind speeds typically increase with altitude and wind is subject to less disruption). As such, there is a trend towards building wind turbines with towers having much greater length. Further, the growth of offshore wind turbines is an additional driving factor towards larger and taller wind turbines.

As wind turbines grow taller the installation process becomes more challenging such that there is a need for effective methods and apparatus for successful installation of tall wind turbines. Conventionally, the wind turbine tower is constructed of a series of longitudinally stackable tubular sections which must be placed and secured end on end. The assembly process therefore comprises first installing a base section of the tower (for example embedded on a platform or foundation) before installing the tower sections in sequence followed by a nacelle and blades on the final section. This installation is carried out using extremely large cranes, but the size of the cranes is such that significant work and infrastructure is required to merely position and install the cranes before work can commence on the wind turbine itself. For example delivery of the parts of a crane to an installation site may require some 80 semi-trailers. Furthermore, it may be very challenging, and require acceptable weather conditions, to install parts of the wind turbine, particularly the uppermost parts, when they are lifted by a crane separate from the tower, for example because of relative movement of the crane and the tower.

Accordingly, the applicant has proposed (in their co-pending Norwegian patent applications NO20201367, NO20201368, NO20201369 all having a filing date of 11 Dec. 2020) an apparatus and method for performing parts of an operation to install a tower for a wind turbine in which an apparatus comprising a travelling car for travelling up and down along an installed tower section of the wind turbine and for carrying an item to be installed as part of the wind turbine. This apparatus and method provides significant potential advantages over the conventional, crane based, methods of installation. Embodiments of the invention seek to provide further improvements and/or alternatives to the apparatus and method.

### SUMMARY

According to a first aspect of the invention, there is provided a wind turbine tower installation apparatus for installing a tower comprising a plurality of longitudinally stackable sections, wherein the apparatus comprises a frame comprising a guide for positioning the apparatus on an installed portion of a tower, a platform for supporting wind turbine components on the frame, and at least one transverse positioning mechanism for transversely positioning the supported wind turbine component in alignment with the tower; and a lifting mechanism for moving the apparatus longitudinally up and down the tower, wherein the apparatus is characterized by the at least one transverse positioning mechanism further comprising: an adaptor frame defining a collar for receiving and aligning the end faces of the free end of the installed portion of the tower and the adjacent end of the subsequent tower section.

The adaptor frame may further comprise an adjustment mechanism. The adjustment mechanism may be configured for correcting the cross-sectional shape of one or both of the end faces. For example, the adjustment mechanism may remove or reduce any non-conformity or irregularity in the cross-sectional shape of the end faces. The tower may typically be specified as having a circular profile but in practice when the tower is installed the profile is found to have some non-conformity for example it may have a degree of ovality to its profile (this may for example be a result of manufacturing tolerances or resultant of the handling or storage of the tower between manufacturing and installation). As such, the adjustment mechanism may be intended to return or adjust the end section of the tower into close tolerance with the intended circular form.

The adjustment mechanism may further comprise a locking mechanism for retaining the end of the tower section in the adaptor frame. In particular the adjustment mechanism may provide a locking mechanism to retain the free end of the uninstalled tower section in the adaptor frame. For example, this may allow the uninstalled tower section to be inserted into the adaptor frame and secured prior to moving the adaptor frame into position on the free end of the installed section (thus positioning the subsequent tower section). Adjustments to the profile of end of the uninstalled tower section may be performed prior to or subsequent to positioning on the installed tower section.

The adjustment mechanism may radially engage a periphery of the tower proximal to the end face. The adjustment mechanism may force the end section of the tower to deform into conformity with the profile of the adaptor frame. The periphery of the tower proximal to the end face may comprise a side wall of the tower section.

The adjustment mechanism comprise a plurality of circumferentially distributed engagement members. The engagement members may comprise a plurality of radial fingers. Each radial finger may project radially from the adaptor frame and have head to engage a surface of the end section of the tower.

In one example, each radial finger may project inwardly from the adaptor frame and have a head to engage an internal surface of the end section such that the fingers outwardly radially load the end section. In this arrangement the fingers may force the external surface of the end section into conformity with an internal alignment surface of the adaptor frame. The internal alignment surface of the adaptor frame may for example be an internal circumferential wall of the collar.

In another example, each radial finger may project inwardly from the adaptor frame and have a head to engage an external surface of the end section such that the fingers inwardly radially load the end section.

The end section of the tower section may include a feature, for example a circumferential rib or groove for seating the adaptor frame. For example, the rib or groove may provide a seat for the head of the radial fingers of the engagement members.

The apparatus of embodiments may also help enable novel methods of assembly. As such, a further aspect of the invention provides a method of erecting a wind turbine tower, the method comprising the steps of:
installing a longitudinal tower section
attaching a moveable installation apparatus to the installed tower section; providing at least one subsequent longitudinal tower section on the installation apparatus;
using the movable installation apparatus to lift the at least one tower section to the free end of the installed tower; positioning an adaptor frame around the free end of the one tower section; and aligning the tower sections using the adaptor frame.

It may be appreciated that the order of the steps in the method is not considered limiting. In some embodiments the adaptor frame may be positioned around the subsequent tower section before being positioned around the free end of the installed tower section. The method may for example comprise the step of engaging and retaining the subsequent tower section in the adaptor frame and using the adaptor frame to move the tower section.

The method may comprise adjusting the end profile of at least one of the tower sections. Adjustment may be achieved by clamping the end in the adaptor frame. Adjustment may correct the shape of the end for example remove or reduce any non-conformity or irregularity in the cross-sectional shape of the end. The method may comprise adjusting the shape of both ends prior to aligning the tower sections. For example, the method may comprise adjusting the end profile of both tower sections prior to inter-engaging the tower sections.

Methods and apparatus in accordance with embodiments may enable greater alignment accuracy between tower sections particularly when any non-conformity in the end profiles is corrected. As such, methods and apparatus may enable a variety of interconnection arrangements between tower sections (in contrast to conventional methods where a simple bolted abutment joint between adjacent flanges may be necessary but require significant manual work). In some embodiments the method may, for example, comprise forming a lap joint between the tower sections. The method may comprise engaging a clamping ring between the ends of the tower segments after the sections are aligned.

Accordingly, in a further aspect of the invention, there is provided a wind turbine support tower comprising: a plurality of longitudinal tower sections, the tower sections being stacked end-to-end to form the tower, wherein each tower section comprises a hollow tubular member and a mating interface is provided at adjacent ends of respective tower sections, characterised by the mating interface comprising complimentary sleeve portions formed at the end of the tower section, the sleeve portions being configured to be coaxially adjacent when the tower sections are stacked end-to-end and wherein one of sleeve portions comprises a radially displaceable locking ring and the other of the sleeve portion comprises a radially extending feature for engaging the locking ring. The radially extending feature may for example be a recess or flange. The radially extending feature may engage or abut a radially adjacent surface of the locking ring.

The radially displaceable locking ring may comprise a plurality of radial bolts for positioning the locking ring. The locking ring may comprise a plurality of circumferential segments.

The mating interface may further comprise at least one radially extending flange for axially aligning the sleeve portions. The at least one radially extending flange may abut an end face of the tower section and may, for example be axially inward of the sleeve portion. Both sleeve portions may terminate at a radially extending flange.

The wind turbine support tower may further comprise an adaptor frame defining a collar for receiving and aligning the mating interface, provided at adjacent ends of respective tower sections, during assembly. In some embodiments the tower may comprise a specific adaptor frame for each section-to-section connection of the tower.

According to yet a further aspect of the invention, there is provided the adaptor frame of the wind turbine installation apparatus in accordance with the invention, the adaptor frame defining a collar for receiving and aligning end portions of the free end of the installed portion of the tower and the adjacent end of the subsequent tower section. The inventors discovered that the adaptor frame may actually be used without the wind turbine tower installation apparatus of the invention, for instance when the tower sections are lifted and placed on top of each other using a crane. In such scenario also the adaptor frame may be lifted and placed on the tower being built, facilitating the alignment of the tower section to be placed to the tower sections already placed.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Whilst the invention has been described above, it extends to any inventive combination of the features set out above or in the following description or drawings.

### BRIEF DESCRIPTION OF THE DRAWINGS

Embodiments of the invention may be performed in various ways, and embodiments thereof will now be described by way of example only, reference being made to the accompanying drawings, in which:

FIGS. 1 to 14 illustrate parts of an operation to install a wind turbine which may incorporate embodiments of the invention;

FIGS. 15 to 21 illustrate apparatus and methods in accordance with embodiments of the invention.

### DETAILED DESCRIPTION OF THE EMBODIMENTS

Note that the embodiments shown in the figures are mere examples of the invention, and that they are not necessarily drawn to scale. Other embodiments being configured differently from those shown in the figures may be within the scope of the invention according to the claims.

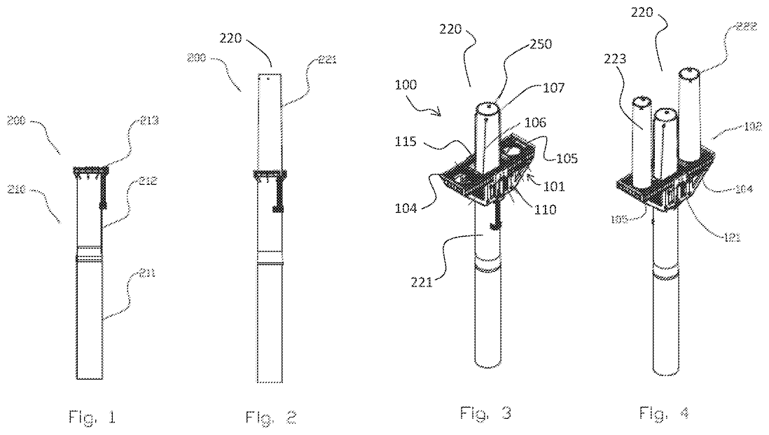

As noted above, the applicant has proposed an apparatus and method for performing parts of an operation to install a tower for a wind turbine. This apparatus and method will be briefly described with reference to FIGS. 1 to 14. These illustrations show a wind turbine at different points in time during installation. It will be appreciated that the steps shown are not considered limiting on the present invention but are provided for reference.

FIG. 1 shows an example of a base 210 for a wind turbine 200. The base 210 typically comprises a foundation piece 211 and a transition piece 212. The transition piece 212 includes a base working platform 213. Methods in accordance with embodiments of the invention may include the step of providing the base 210 or, alternatively, the base 210 may be of another type, e.g. any other type of base known from the prior art. For example, the provision of a foundation 211 and transition 212 pieces may be typically in an offshore foundation but may not be required in other installations. The first tower section in a land-based installation may, for example, be directly bolted to a concrete foundation. It will thus, be appreciated that embodiments are applicable to both land and offshore applications. FIG. 2 shows the same wind turbine 200, with the addition of a first, base, section 221 of the tower 220 of the wind turbine 200. It may be appreciated the tower 220 of the wind turbine 200 comprises a plurality of such sections which are longitudinally stackable to form the full length of the tower 220. The base section 221 may typically, but not necessarily, be installed atop the transition piece 212 by use of a crane device (not shown).

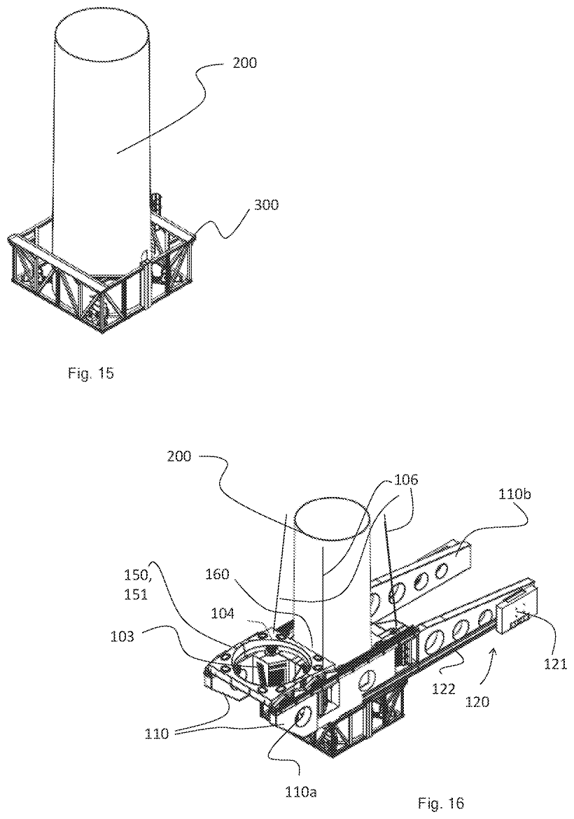

As shown in FIG. 3, once a first tower section 221 has been installed, an installation apparatus 100 in accordance with embodiments may be connected to the tower 220. The apparatus 100 will be described in further detail below but generally comprises a movable portion, referred to herein as a “travelling car” 101, which travels up and down along the longitudinal axis of the tower. The travelling car 101 is carried on load bearing ropes 106 which are attached to a set of lifting lugs 107 provided at, or proximal, to the free end of the installed section 221 of the tower 220. One or more winches are provided on the travelling car 101 to act upon the ropes 106. Prior to the installation of the travelling car 101, a landing frame 300 (as shown in FIG. 15) or resting flange may be installed on the tower 220 or base 210 to provide a fixed base for the travelling car.

The travelling car 101 comprises a frame 110 defining a generally horizontal platform 102 (see FIG. 4) which extends transversely beyond the tower 220. A central portion of the frame 110 surrounds the installed tower section 221 and provides a guide 115 for positioning the apparatus 100. The guide 115 may, for example, include wheels or rollers (not shown) which engage and move along the outer surface of the tower section 221. The apparatus 100 further includes a mechanism for transversely positioning supported wind turbine components in alignment with the tower (i.e. for moving the component or components laterally along the platform 102). In the embodiment of FIGS. 1 to 14, two such transverse positioners 104, 105 are provided. Each of the first and the second transverse positioner 104, 105 are configured for carrying an item to be installed as part of the wind turbine 200. The travelling car 101 may further include a counter-balance device 120 (best seen in FIG. 16) for balancing the travelling car 101. The counter-balance device may include at least one weight 121 moveably mounted on a track 122 associated with the frame 110 such that the weight 121 may be moved transversely to counter the weight of components carried on the travelling car 101.

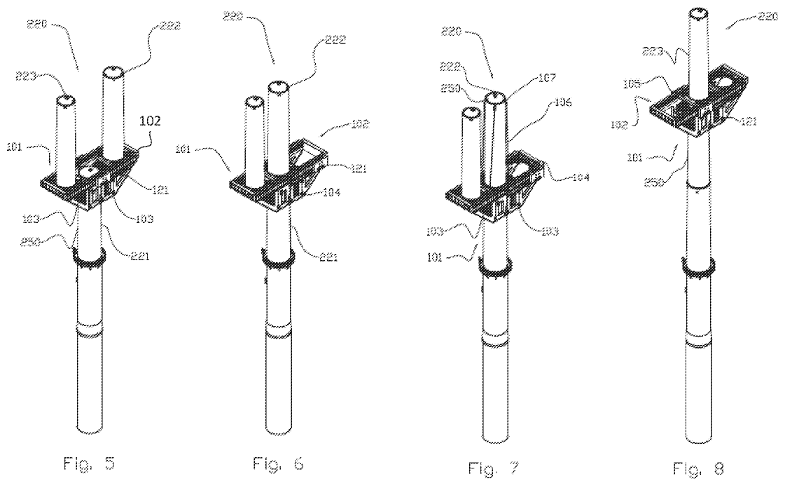

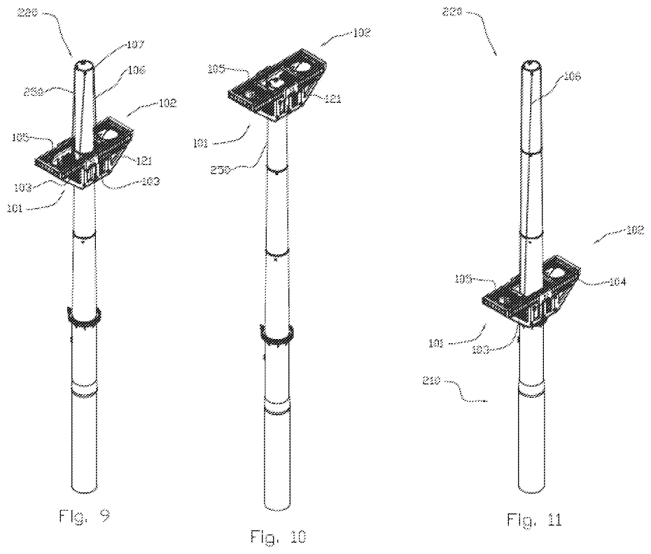

In FIG. 4, a first and a second subsequent sections 222, 223 for the tower 220 have been secured respectively on the first and the second transverse positioners 104, 105 of the platform 102 (with the transverse positioners in their initial positions). A crane may for example be used to load the sections onto the apparatus 100. As shown in FIG. 5, the travelling car 101, carrying the first and the second sections 222, 223, moves to an elevated position. In this elevated position, the deck 102 is slightly above the uppermost installed section of the tower 250.

Subsequently, in FIG. 6, the first transverse positioner 104 of the deck 102 has moved to a central position of the travelling car 101 to transversely position its supported wind turbine component directly above the uppermost installed section (base section 221) of the tower 220. To balance the travelling car 101 after/while moving the first section 222 to the central position, the weight 121 of the counter-balancing device has been moved to the side of the travelling car 101 where the first section 222 was held prior to it being moved centrally. Moving the weight 121 in the opposite direction of the first section 222, offsets an imbalance that would otherwise have been caused by the movement of the first section 222. The tower section 221 and 222 may then be secured together (as will be described in further detail below).

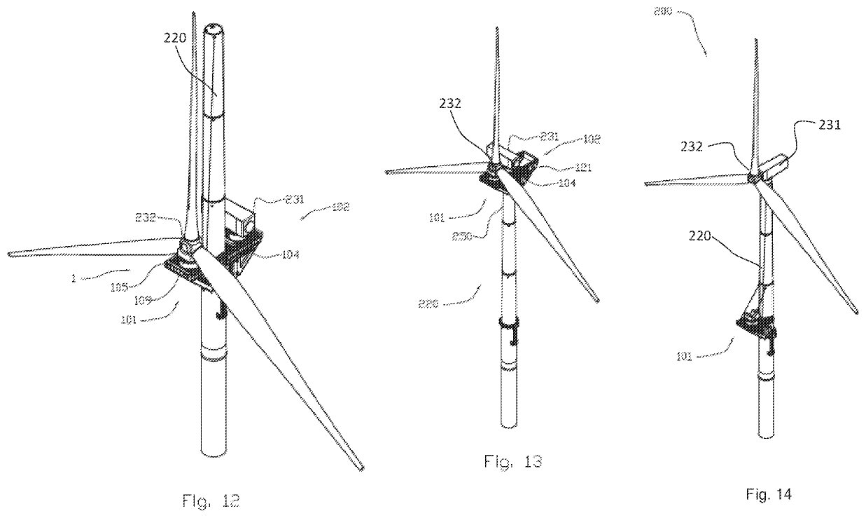

As can be further seen in FIG. 7, after installing the section 222 the lifting lugs 107 and the ropes 106 of the lifting mechanism are moved to the upper end of the installed portion. Thus, the winches 103 of the lifting mechanism may be used to move the travelling car 101 longitudinally along the next segment. This enables the positioning and connection of the next segment 223 to be installed in substantially the same manner as section 222 and as shown in FIG. 8.

Once the final tower section is installed (in this case 223) the lifting mechanism is again attached to the upper end of the installed tower section, as shown in FIG. 9. The travelling car 101 is then able to move longitudinally along the tower 220 between the upper end (the position shown in FIG. 10) and its landing frame, which, as shown in FIG. 11, may be at the connection between the tower 220 and base 210.

As shown in FIGS. 12 to 14, with the tower fully erected the installation apparatus 100 may be used to install subsequent wind turbine components. For example, the apparatus may be used for the installation of a nacelle 231 and a rotor 232. As shown in FIG. 12 the nacelle 231 and rotor 232 may be mounted on the travelling car 101 for lifting longitudinally along the tower 220. In FIG. 13, the travelling car 101 has been moved to the top of the tower 220 and the transverse positioners 104, 105 may be used to position the nacelle 231 and rotor 232. When the propeller with rotor blades 232 has been installed, the wind turbine 200 may be fully installed, or the part of the installation of the wind turbine 200 that involves use of the apparatus 100 may be completed as shown in FIG. 14.

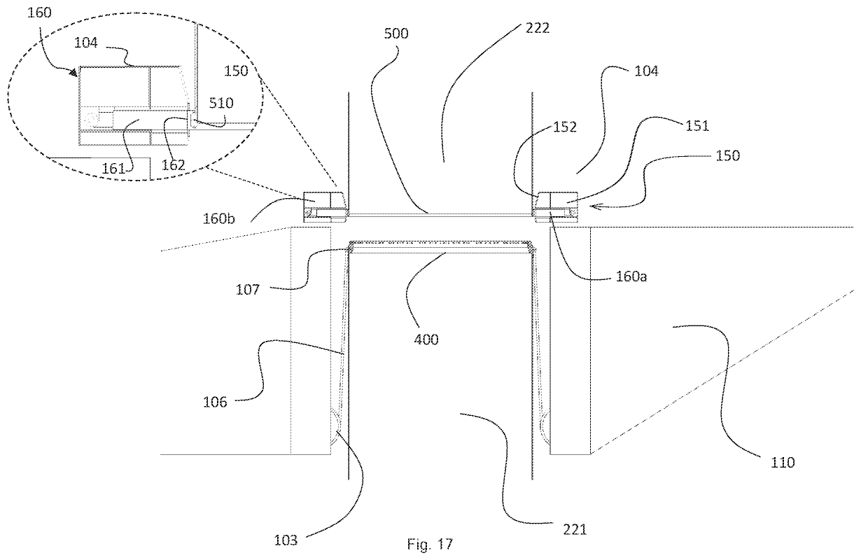

An installation apparatus 100 is shown in further detail in FIGS. 15 and 16. FIG. 15 shows the landing frame 300 for the travelling car 101. The landing frame 300 may typically be configured for supporting the travelling car 101 when the travelling car is sitting at the base 210 of the wind turbine 200, for example when installing the travelling car 101 onto the tower or when the apparatus 100 is not in use. As seen in FIG. 16 the travelling car comprises a frame 110 which is formed from two side support trusses 110a and 110b which extend transversely along opposing sides of the tower. The frame 110 is constructed in two interconnectable halves which can be joined around the tower in use. The upper plane of the frame 110 defines the platform onto which is mounted at least one transverse positioning mechanism 104. The positioning mechanism 104 includes an adapter frame 150 defining a collar 151, the positioning mechanism 104 being configured for aligning tower segments as will be explained further below (with reference to FIG. 17). It may also be noted that external sides of the frame 110 mounts the counter-balance system 120 with a weight 121 on rails.

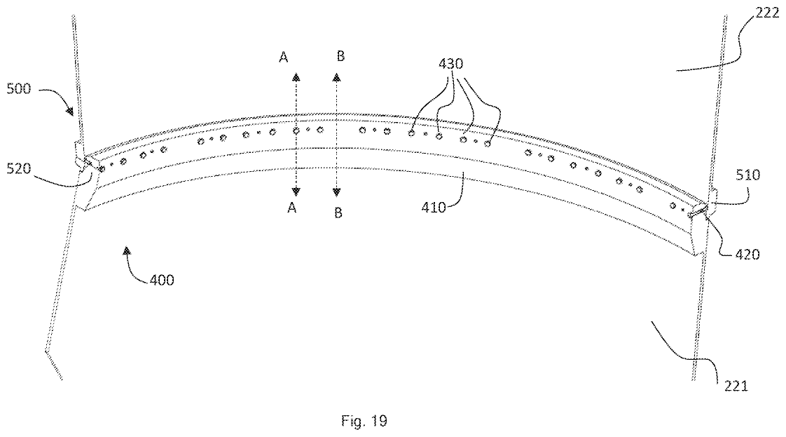

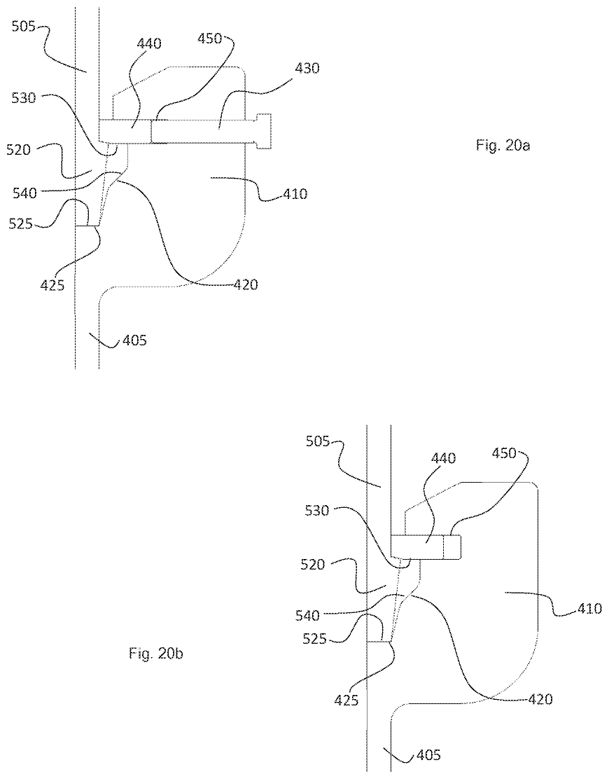

FIG. 17 shows a cross section of the installation apparatus 100 with a tower section 222 retained in the adapter frame 150 of the positioner 104 and being positioned into alignment with an already installed tower section 221 prior to attachment. The tower segments 221 and 222 include respective end portions 400, 500 configured to inter-connect during tower assembly. The end portions 400, 500 are explained in further detail below (with reference to FIGS. 19 and 20). The frame 110 is shown in general outline and is surrounding the upper end of tower segment 221 with the winches 103 having used the lifting ropes 106 (attached to lugs 107 at the top of the segment 221) to raise the apparatus and thereby lift the subsequent tower section 222. The adapter frame 150 of the positioner 104 is provided to precisely align the end of the tower sections to improve the connection procedure. In particular, it may be noted that the adaptor frame 150 includes an adjustment mechanism comprising a plurality of radially acting linear actuators 160. Whilst only two radially opposed actuators 160a, 160b are shown in the cross section it will be appreciated that a plurality of actuators 160 are circumferentially distributed around the adaptor frame 150.

As shown in the detail aspect of FIG. 17, each actuator 160 comprises a radially extending finger 161 terminating in a head 162 configured for engaging a portion of the end portion 500 of the tower section. The end portion of the tower 500 may include a location feature such as circumferential rib 510 onto which the head 162 of the actuators can accurately locate.

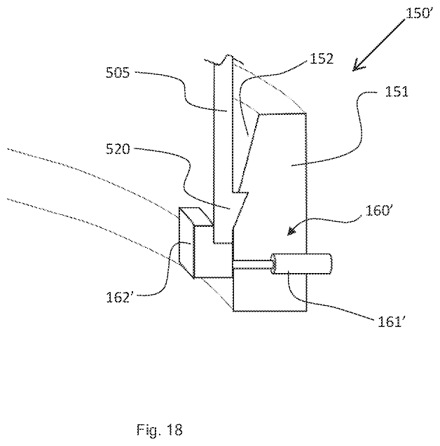

Initially, the actuators 160 may be used as a locking mechanism to engage and retain the tower segment end 500 in position in the adapter frame 150 (although alternatively a separate locking mechanism may be provided). Once secured the actuators 160 act as an adjustment mechanism by applying a force onto the end section 500. Due to the distributed nature of the actuators 160 the force applied can be applied around the full periphery of the end wall 505 (see FIG. 18) of the end section 500. The adjustment mechanism can therefore remove any non-conformity, for example ovality, in the cross-sectional shape of the end section 500.

An alternate configuration of the adaptor frame 150′ is shown in FIG. 18. In this embodiment the actuators 160′ are configured to act on the internal rather than external side of the side wall 505 of the end section. As such, the fingers 161′ either extend inwardly past the side wall 505 or include a head 162′ that extends inwardly past the side wall 505. Whilst this arrangement may require openings to be provided in one or both of the end sections 400, 500 for the actuators 160 to pass through they may provide some advantages over the embodiment of FIG. 17. For example, in the internal acting embodiment it can be noted that the end 500 of the tower may be supported vertically on the actuator 160′. Further, by having the actuators 160′ act radially outwardly on the side wall 505 the actuators 160′ of the adaptor frame 150′ can urge the wall 505 of the tower end against the inner wall 152 of the collar 151 to help with alignment.

As the apparatus according to embodiments enables non-conformity (such as ovality) to be removed from the tower end 500 or 400 prior to connection embodiments enable the use of a finer tolerance attachment between the tower sections. In contrast, conventional tower sections are typically connected by axial aligned bolts extending through abutting flanges at the interface between the sections. Such bolted connections typically require a significant amount of manual labour for connection.

A partial cross-section of the connection interface between tower sections 221 and 221 in accordance with embodiments is shown in FIG. 19 and in the cross-section details of FIGS. 20a and 20b which are respectively taken through sections A-A and B-B of FIG. 19. The upper end 400 of the lower section 221 includes an interface arrangement formed as a radial flange 410. The flange 410 extends radially inwardly from the wall 405 and extends around the entire circumference of the tower section 221. The flange includes a seat 425 which aligns with and receives end face 525 of the wall 505 of the adjoining end 500 of the upper section 222. A tapered wall 420 extends away from the seat 425 towards the upper portion of the flange 410. The upper portion of the tapered wall includes a recess 450 into which a locking ring 440 is slidably received. The locking ring is radially displaceable relative to the wall 405 and flange 410. It may be appreciated that a radially displaceable locking ring may typically be a ring assembly which is radially expandable, as such it may include at least one discontinuity in the circumferential direction, for example it may typically be formed from a plurality of circumferential segments. The radial position of the locking ring 440 within the recess 450 is controlled by the adjustment of a plurality of circumferentially distributed radial bolts 430. In particular, the bolts 430 may be tightened to increase the extent to which the locking ring 440 projects radially from the recess 450.

The lower end 500 of the upper wing section 222 is provided with a complementary interface arrangement formed by flange 520. The flange 520 extends from a first end proximal to the end face 525 (which in use abuts the seat 425 of the flange 410). The flange 520 forms a radially aligned locking surface 530 (which could optionally be part of a recess) which faces away from the open end of the tower section. A tapered ramp surface 540 is provided on the flange axially forward of the locking surface 530.

The end sections 400, 500 provide respective sleeve portions of the tower sections 221 and 222 which form a lap joint between the sections in use. When aligned and adjusted by the adaptor frame 150 of the installation apparatus 100, the end section 500 is able to pass over the flange 410 of the end section 400. As the sections 221 and 222 are brought axially together (by lowering the upper section 222) the ramp surface 530 and tapered wall 420 will slide across each other until the end face 525 abuts the seat 425 formed in the flange 410. In this position the locking ring 440 will have axially aligned beyond the locking surface 540 of the flange 520. The plurality of radial bolts 430 may then be fastened to secure the locking ring 440 in position behind the flange 520 with the radial locking surface 530 and radial face of the locking ring 440 ensuring that the engagement between the sleeve portions of the tower sections is secure.

As already mentioned in the introduction, the adaptor frames 150, 150′ as illustrated in FIGS. 17-20 may also be used without the other parts of the wind turbine installation apparatus, by simply being lifted and placed by a crane on the tower being built, section-by-section. Before placement of each section, first the respective adaptor frame 150, 150′ is placed allowing for alignment of the sections in the manner described in this specification.

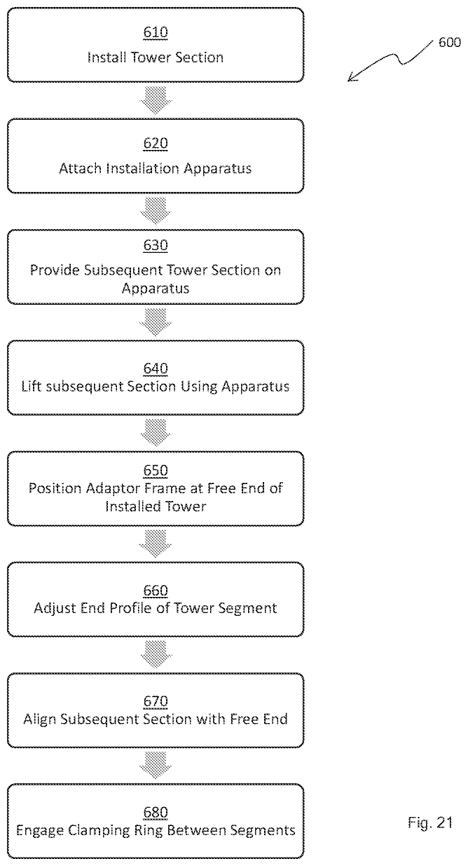

The method according to embodiments of the invention is shown schematically in FIG. 21. The method 600 includes the initial step 610 of installing a tower section followed by the step 620 of attaching an installation apparatus to the installed tower section. A further tower section is then provided (step 630) and lifted using the lifting apparatus 100 in step 640. These initial steps may be generally as described above with reference to FIGS. 1 to 14. The method further comprises positioning an adaptor frame 150 at the free end of the installed tower (step 650). The adaptor frame 150 is then used to adjust the end profile of at least one of the end sections 400, 500, in step 660, by using the actuators 160 of the adaptor frame 150 to remove any non-conformity from the cross-sectional shape of the end-section. In the next step 670, the ends of the tower sections are aligned such that the end sections 400 and 500 axially overlap. In step 680 the locking ring 440 is engaged to retain the end sections 400, 500 in a clamped arrangement such that the tower sections assembly is complete.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

Although the invention has been described above with reference to preferred embodiments, it will be appreciated that various changes or modification may be made without departing from the scope of the invention as defined in the appended claims. For example, whist the illustrated embodiment uses the adjustment mechanism to adjust the shape of the end of the subsequent tower section in some embodiments the mechanism may alternatively or additionally adjust the shape of the end of the installed tower section. Further, whilst the interface between tower sections in the illustrated embodiment is generally internal to the tower (having internal bolts and an outwardly projecting retaining ring) it will be appreciated that this arrangement could be reversed.

1. A wind turbine tower installation apparatus for installing a tower comprising a plurality of longitudinally stackable sections, wherein the apparatus comprises:
a frame comprising
a guide for positioning the apparatus on an installed portion of a tower,
a platform for supporting wind turbine components on the frame, and
at least one transverse positioning mechanism for transversely positioning the supported wind turbine component in alignment with the tower and
a lifting mechanism for moving the apparatus longitudinally up and down the tower,
the at least one transverse positioning mechanism comprising:
an adaptor frame defining a collar for receiving and aligning the end portions of the free end of the installed portion of the tower and the adjacent end of the subsequent tower section.

2. The wind turbine installation apparatus as claimed in claim 1, wherein the adaptor frame further comprises an adjustment mechanism for correcting the cross-sectional shape of one or both of the end faces.

3. The wind turbine installation apparatus as claimed in claim 2, wherein the adjustment mechanism further comprises a locking mechanism for retaining the free end of the uninstalled tower section in the adaptor frame.

4. The wind turbine installation apparatus as claimed in claim 2, wherein the adjustment mechanism radially engages a periphery of the tower proximal to the end face to force the end section of the tower to deform into conformity with the profile of the adaptor frame.

5. The wind turbine installation apparatus as claimed in claim 4, wherein the adjustment mechanism comprises a plurality of circumferentially distributed engagement members.

6. The wind turbine installation apparatus as claimed in claim 5, wherein the engagement members comprise radial fingers, each projecting inwardly from the adaptor frame and having a head to engage an internal surface of the end section, and wherein the fingers outwardly radially load the end section to force an external surface of the end section into conformity with an internal alignment surface of the adaptor frame.

7. A method of erecting a wind turbine tower, the method comprising the steps of:
installing a longitudinal tower section;
attaching a wind turbine installation apparatus in accordance with claim 1 to the installed tower section;
providing at least one subsequent longitudinal tower section on the installation apparatus;
using the movable installation apparatus to lift the at least one tower section to the free end of the installed tower;
positioning an adaptor frame around the end of one tower section; and
aligning the tower sections using the adaptor frame.

8. The method of claim 7, further comprising:
adjusting the end profile of at least one of the tower sections by clamping the end in the adaptor frame to correct the cross-sectional shape of the end.

9. The method of claim 8, further comprising adjusting the end profile of both tower sections prior to inter-engaging the tower sections.

10. The method of claim 7, further comprising:
engaging a clamping ring between the ends of the tower segments.

11. The method of claim 10, further comprising:
forming a lap joint between the tower sections.

12. A wind turbine support tower comprising:
a plurality of longitudinal tower sections, the tower sections being stacked end-to-end to form the tower, wherein each tower section comprises a hollow tubular member and a mating interface is provided at adjacent ends of respective tower sections, the mating interface comprising complimentary sleeve portions formed at the end of the tower section, the sleeve portions being configured to be coaxially adjacent when the tower sections, are stacked end-to-end and wherein one of sleeve portions comprises a radially displaceable locking ring and the other of the sleeve portions comprises a radially extending feature for engaging the locking ring.

13. The wind turbine support tower as claimed in claim 12, wherein the radially displaceable locking ring comprises a plurality of radial bolts for positioning the locking ring.

14. The wind turbine support tower as claimed in claim 12, wherein the locking ring comprises a plurality of circumferential segments.

15. The wind turbine support tower as claimed in claim 12, further comprising an adaptor frame defining a collar, for receiving and aligning the mating interface, is provided at adjacent ends of respective tower sections during assembly.

16. The adaptor frame of the wind turbine tower installation apparatus in accordance with claim 1.

17. A wind turbine installation apparatus as claimed in claim 3, wherein the adjustment mechanism radially engages a periphery of the tower proximal to the end face to force the end section of the tower to deform into conformity with the profile of the adaptor frame.

18. A method of erecting a wind turbine tower, the method comprising the steps of:
installing a longitudinal tower section;
attaching a wind turbine installation apparatus in accordance with claim 2 to the installed tower section;
providing at least one subsequent longitudinal tower section on the installation apparatus;
using the movable installation apparatus to lift the at least one tower section to the free end of the installed tower;
positioning an adaptor frame around the end of one tower section; and
aligning the tower sections using the adaptor frame.

19. A method of erecting a wind turbine tower, the method comprising the steps of:
installing a longitudinal tower section;
attaching a wind turbine installation apparatus in accordance with claim 3 to the installed tower section;
providing at least one subsequent longitudinal tower section on the installation apparatus;
using the movable installation apparatus to lift the at least one tower section to the free end of the installed tower;
positioning an adaptor frame around the end of one tower section; and
aligning the tower sections using the adaptor frame.

20. A method of erecting a wind turbine tower, the method comprising the steps of:
installing a longitudinal tower section;
attaching a wind turbine installation apparatus in accordance with claim 4 to the installed tower section;
providing at least one subsequent longitudinal tower section on the installation apparatus;
using the movable installation apparatus to lift the at least one tower section to the free end of the installed tower;
positioning an adaptor frame around the end of one tower section; and
aligning the tower sections using the adaptor frame.
